(19) United States
(12) Patent Application Publication
(10) Pub. No.: US 2026/0284802 A1
(43) Pub. Date: Sep. 24, 2026

(54) HIGH-PERFORMANCE WELDING DEVICE FOR THICK-WALL ELECTROGAS UPRIGHT WELDING BASED ON LIQUID NITROGEN RAPID COOLING ASSISTANCE

(71) Applicant: Tianjin University, Tianjin (CN)

(72) Inventors: Yongdian Han, Tianjin (CN); Zhaowei Xue, Tianjin (CN); Lianyong Xu, Tianjin (CN); Lei Zhao, Tianjin (CN); Kangda Hao, Tianjin (CN)

(73) Assignee: Tianjin University, Tianjin (CN)

(21) Appl. No.: 19/373,705

(22) Filed: Oct. 29, 2025

(30) Foreign Application Priority Data
Mar. 24, 2025 (CN) 202510348475.8

(51) Int. Cl. B23K 37/003; B23K 9/035; B23K 9/16

(52) U.S. Cl. CPC B23K 37/003; B23K 9/035; B23K 9/16

(57) ABSTRACT

The present disclosure provides a high-performance welding method and device for thick-wall electrogas upright welding based on liquid nitrogen rapid cooling assistance. The method including assembling thick plates with a thickness greater than 30mm as a pair to form a welding groove, followed by performing electrogas upright welding on the welding groove. During the welding, the welding surface is locally and rapidly cooled using liquid nitrogen, while the back side of the welding surface is cooled using water-cooling, thereby increasing the cooling rate of the heat-affected zone of the welded joint with the assistance of rapid liquid nitrogen cooling. In the electrogas upright welding process of the present disclosure, the combination of liquid nitrogen cooling on the welding surface and water-cooling on the back side of the welding surface enables an increased cooling rate in the welding heat-affected zone with the assistance of rapid liquid nitrogen cooling.

### CROSS-REFERENCE TO RELATED APPLICATION

This application claims the priority benefit of Chinese application serial no. 202510348475.8, filed on Mar 24, 2025. The entirety of the above-mentioned patent application is hereby incorporated by reference herein and made a part of this specification.

### BACKGROUND

### Technical Field

This application belongs to the technical field of welding, and more specifically, relates to a high-performance welding method and device for thick-wall electrogas upright welding based on liquid nitrogen rapid cooling assistance.

### Description of Related Art

In recent years, with the gradual development of China's offshore oil and gas resource extraction towards harsh conditions such as low-temperature deep water, the thickness of steels used for offshore platform jacket has been increasing, posing higher demands on welding efficiency and the quality of welded joints. Currently, electrogas welding (EGW), as a high-efficiency high-heat-input welding technology, is gradually replacing traditional multi-pass welding processes for thick plates. Single-wire electrogas welding can achieve a maximum heat input of 350 kJ/cm, enabling single-pass welding of 40 mm thick plates. For even greater plate thicknesses, twin-wire electrogas welding can reach a heat input of 750 kJ/cm, achieving single-pass welding of plates up to 85 mm thick. However, excessively high heat input inevitably leads to embrittlement in the weld heat-affected zone, reducing the overall toughness of the welded joint.

To improve the toughness of welded joints, CN116890180A discloses a groove for high-strength steel thick plate welded joints and a twin-wire electrogas upright welding method. This method reduces the heat input of electrogas welding by decreasing the groove angle to reduce the cross-sectional area of the groove. However, the reduction of the groove angle is limited by the space available for oscillation of the welding torch, and when the plate thickness increases further, the heat input rapidly increases. CN217832376U discloses a device for enhancing the cooling effect of electrogas upright welding with a water-cooled slide. It achieves increased cooling effect by installing a water-cooling slide device. However, the primary function of this slide is to force the formation of the welded joint, and the water-cooling mainly serves to prevent the slide from melting. Furthermore, it can only remove part of the heat from the welded joint area and cannot achieve cooling of the heat-affected zone. Therefore, electrogas upright welding is currently mostly applied in scenarios where performance requirements are not high. According to the harsher environment of low-temperature offshore conditions, the embrittlement problem of the coarse-grained heat-affected zone in welded joints has severely restricted its application.

### SUMMARY

In view of defects in the related art, the disclosure provides a high-performance welding method and device for thick-wall electrogas upright welding based on liquid nitrogen rapid cooling assistance, aiming to solve the problem of excessive heat input in existing electrogas upright welding, which leads to poor toughness of the welded joint.

According to one aspect of this disclosure, a high-performance welding method for thick-wall electrogas upright welding based on liquid nitrogen rapid cooling assistance is provided, the method includes at least the following steps: providing a thick plate to be welded with a thickness greater than 30 mm and assembling the thick plate to be welded as a pair to form a welding groove, then electrogas upright welding is used to weld the welding groove; during welding, performing liquid nitrogen cooling on a welding surface to cool the welding surface locally and quickly while performing water-cooling on a back side of the welding surface for cooling, thereby increasing a cooling rate of a heat-affected zone of a welded joint under assistance of a liquid nitrogen rapid cooling back side of the welding surface.

Through the above technical solution, compared with the existing technology, since in the method a liquid nitrogen cooling is adopted to perform local rapid cooling on the welded joint of the welding surface, it can effectively increase the cooling rate of the heat-affected zone of the welded joint, avoiding the embrittlement of the coarse-grained heat-affected zone of the welded joint.

As an embodiment, when the wall thickness of the thick plate to be welded is less than 50mm, the welding groove is a single-sided V-groove, and a back side of the welding surface is cooled by indirect water-cooling; when the wall thickness of the thick plate to be welded is greater than or equal to 50mm, the welding groove is an X-groove, during welding the first side, the back side of the welding surface is cooled by direct water-cooling, and during welding the other side, the back side of the welding surface is cooled by indirect water-cooling.

As an embodiment, the flow rate of the liquid nitrogen is 0.1 L/min to 0.2 L/min.

According to another aspect of this disclosure, a high-performance welding device for thick-wall electrogas upright welding based on liquid nitrogen rapid cooling assistance is provided, used for executing the above method. This welding device includes a welding torch, a back water-cooling assembly, and a front water-cooling assembly, whereinthe welding torch is used for welding the welding groove through electrogas upright welding; the back water-cooling assembly is arranged on the back side of the welding surface of the thick plate to be welded for performing water-cooling on the back side of the welding surface; the front water-cooling assembly is arranged on the welding surface of the thick plate to be welded and moves with the welding torch. The front water-cooling assembly includes a water-cooling slider and a protective gas channel, a cooling water channel, and a liquid nitrogen injection channel arranged inside the water-cooling slider. The protective gas channel is used for providing protective gas during the welding process; the cooling water channel is used for introducing cooling water during the welding process to cool the water-cooling slider to prevent it from melting resulting in forced weld formation; the liquid nitrogen injection channel is used for spraying liquid nitrogen onto the welded joint during the welding process to achieve local rapid cooling of the heat-affected zone of the welded joint.

As an embodiment, the protective gas channel is arranged at the center of the water-cooling slider; a first water inlet and a first water outlet of the cooling water channel are arranged on two sides of the protective gas channel, respectively; two liquid nitrogen injection channels are arranged on the two sides of the first water inlet and the first water outlet, respectively.

As an embodiment, each of the two liquid nitrogen injection channels (13) is provided with a first liquid nitrogen injector and a second liquid nitrogen injector therein; the center lines of the first liquid nitrogen injector and the second liquid nitrogen injector are respectively distanced 1 mm to 2 mm away from the outside of the weld fusion line; the distances between the ends of the first liquid nitrogen injector and the second liquid nitrogen injector to the welding surface of the thick plate to be welded is 1 mm to 3 mm.

As an embodiment, when the wall thickness of the thick plate to be welded is less than 50 mm, the back water-cooling assembly includes a back water-cooling backing plate and a water-cooling pipe arranged inside the back water-cooling backing plate; the back water-cooling backing plate is arranged along the length direction of the thick plate to be welded at the root of the welding groove to be welded and clamped tightly to the thick plate to be welded; the water-cooling pipe is distributed in a serpentine pattern inside the back water-cooling backing plate.

As an embodiment, a water inlet of the water-cooling pipe is arranged at the bottom of the back water-cooling backing plate, and a water outlet of the water-cooling pipe is arranged at the top of the back water-cooling backing plate.

As an embodiment, the width of the back water-cooling backing plate is more than 3 times of the maximum groove width of the welding groove.

As an embodiment, when the wall thickness of the thick plate to be welded is greater than or equal to 50 mm, during welding of the first side, the back water-cooling assembly includes a cooling water pipe, and the cooling water pipe moves synchronously with the front water-cooling assembly during welding for spraying water towards the root of the welding groove; during welding of the other side, the back water-cooling assembly includes a back water-cooling backing plate and a water-cooling pipe arranged inside the back water-cooling backing plate; the back water-cooling backing plate is arranged at the root of the welding groove to be welded along the length direction of the thick plate to be welded and clamped tightly to the thick plate to be welded; the water-cooling pipe is distributed in a serpentine pattern inside the back water-cooling backing plate.

In general, the above technical solutions disclosed by the disclosure have the following beneficial effects compared to the related art.
1. The disclosure adopts the method of liquid nitrogen cooling on the welding surface combined with water-cooling on the back side of the welding surface during the electrogas upright welding process for cooling, which increase the cooling rate of the weld heat-affected zone with the assistance of liquid nitrogen rapid cooling and, under the combined effect of both, maximizes the cooling rate of the weld heat-affected zone, reduces the high-temperature residence time, and narrows the width of the heat-affected zone. Thereby, an embrittlement problem of the coarse-grained heat-affected zone of the welded joint is avoided, a toughness of the welded joint is improved, and makes the welded joint more adaptable to the demanding low-temperature marine environment.
2. Meanwhile, the disclosure optimizes the groove shape and the specific method of water-cooling on the back side of the welding surface according to the wall thickness, which further increases the cooling rate, thus enabling a further enhancement in the toughness of the welded joint.

### BRIEF DESCRIPTION OF THE DRAWINGS

FIG. 1 is a top view of the high-performance welding process for thick-wall electrogas upright welding based on liquid nitrogen rapid cooling assistance of 40 mm thick plate provided by embodiment 1.

FIG. 2 is a cross-sectional view of the groove of the high-performance welding process for thick-wall electrogas upright welding based on liquid nitrogen rapid cooling assistance of 40 mm thick plate provided by embodiment 1.

FIG. 3 is a top view of the high-performance welding process for thick-wall electrogas upright welding based on liquid nitrogen rapid cooling assistance of 80 mm thick plate provided by embodiment 2.

FIG. 4 is a cross-sectional view of the groove of the high-performance welding process for thick-wall electrogas upright welding based on liquid nitrogen rapid cooling assistance of 80 mm thick plate provided by embodiment 2.

FIG. 5 is CTOD test curves of the welded joint and the welded joint without cooling in embodiment 1.

FIG. 6 is CTOD test curves of the welded joint and the welded joint without cooling in embodiment 2.

### DESCRIPTION OF THE EMBODIMENTS

In order for the objectives, technical solutions, and advantages of the disclosure to be more comprehensible, the disclosure is further described in detail below in conjunction with the embodiments accompanied with drawings. It should be understood that the specific embodiments described herein are only used to describe the disclosure and are not used to limit the disclosure.

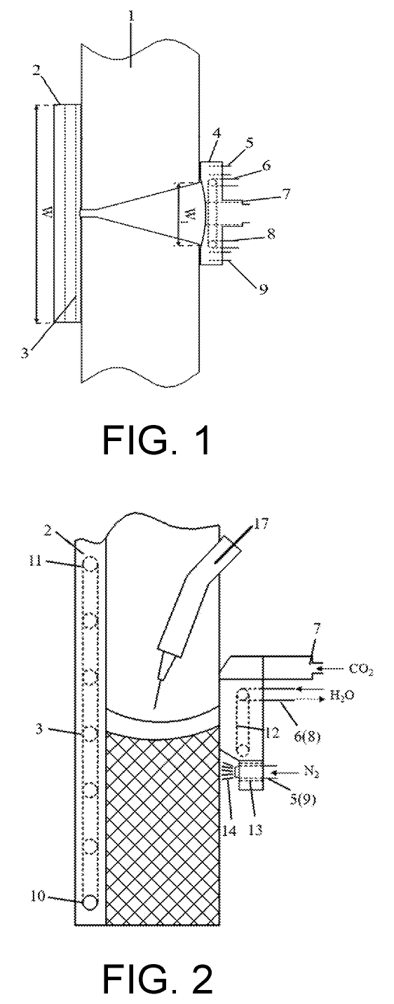

As shown in FIGS. 1 to 4, this disclosure provides a high-performance welding method for thick-wall electrogas upright welding based on liquid nitrogen rapid cooling assistance. Specifically, a thick plate 1 to be welded with a thickness greater than 30mm is assembled to form a welding groove. The welding groove preferably adopts a single-sided V-groove or an X-groove. Then, electrogas upright welding is used to weld the welding groove.

During the welding process, the welding surface of the thick plate 1 to be welded is locally and rapidly cooled using liquid nitrogen cooling. Liquid nitrogen features fast cooling speed, ability to rapidly absorb large amount of heat, and quickly remove heat from the welding joint area, thereby achieving rapid cooling of the heat-affected zone and avoiding embrittlement issues in the coarse-grained heat-affected zone of the welding joint. This makes the welded product more suitable for low-temperature marine environments. Additionally, liquid nitrogen has the advantage of leaving no residual contaminants, ensuring no adverse effects on the welding joint.

Simultaneously, indirect or direct water-cooling is applied to the back side of the welding surface of the thick plate 1 to be welded, thereby enhancing the cooling rate of the heat-affected zone of the welding joint with cooperation of the rapid cooling by liquid nitrogen.

The present disclosure adopts a liquid nitrogen cooling method to locally and rapidly cool the welding surface of the thick plate to be welded, which can effectively increase the cooling rate of the welding heat-affected zone and avoid embrittlement issues in the coarse-grained heat-affected zone of the welded joint.

Furthermore, when the wall thickness of the thick plate to be welded is less than 50 mm, the welding groove is a single-sided V-groove, and indirect water-cooling is applied to the back side of the welding surface of the thick plate to be welded. When the wall thickness of the thick plate to be welded is greater than or equal to 50mm, the welding groove is an X-groove. During welding of the first side, direct water-cooling is used to cool the back side of the welding surface, while during welding of the other side, indirect water-cooling is applied to cool the back side of the welding surface.

Additionally, the groove angle is 30° - 50°, a blunt edge at the root of 3 mm - 5 mm is reserved, and an assembly gap of 2 mm - 3 mm is reserved. The welding current is 320A–480A, the welding voltage is 36V - 44V, and the welding speed is 2.9 cm/min - 3.6 cm/min. The welding torch oscillation amplitude ranges from 10 mm to 15 mm, with a dwell time of 0.4s on each side. The heat input ranges from 240 kJ/cm to 353 kJ/cm. The electrogas upright welding uses a wire diameter of 1.6 mm, with a wire extension of 30 mm - 35 mm. The protective gas used during welding is 100% CO₂, with a gas flow rate of 30 L/min - 35 L/min.

Furthermore, the liquid nitrogen flow rate is 0.1 L/min to 0.2 L/min. If the flow rate is too low, the cooling effect on the welding heat-affected zone will be insufficient. If the flow rate is too high, it will not only lead to excessively high welding costs but also cause the formation of brittle microstructures such as lath martensite/bainite in the heat-affected zone.

According to another aspect of the present disclosure, a high-performance welding device for thick-wall electrogas upright welding based on liquid nitrogen rapid cooling assistance is provided, which is used to apply the above method. The welding device includes a welding torch 17, a back water-cooling assembly, and a front water-cooling assembly. The welding torch 17 is used to perform electrogas upright welding on the welding groove. The back water-cooling assembly is arranged on the back of the welding surface of the thick plate 1 to be welded and is used to perform water-cooling on the back of the welding surface. The front water-cooling assembly is arranged on the welding surface of the thick plate 1 to be welded and moves along with the welding torch 17. The front water-cooling assembly includes a water-cooling slider 4 and a protective gas channel 7, a cooling water channel 12, and a liquid nitrogen injection channel 13 provided inside the water-cooling slider 4. The protective gas channel 7 is used to provide protective gas during the welding process. The cooling water channel 12 is used to introduce cooling water during the welding process to cool the water-cooling slider 4 and prevent the water-cooling slider 4 from melting due to excessive temperature. The liquid nitrogen injection channel 13 is used to spray liquid nitrogen onto the welded joint during the welding process to achieve local rapid cooling.

Furthermore, during the installation of the water-cooling slider 4, its centerline must be strictly aligned with the centerline of the groove to be welded. The protective gas channel 7 is positioned at the center of the water-cooling slider 4. The first water inlet 6 and the first water outlet 8 of the cooling water channel 12 are located on either side of the protective gas channel 7, respectively. During operation, the first water inlet 6 and the first water outlet 8 are connected to a first constant-temperature circulating water tank to enable the provision of circulating cooling water. There are two liquid nitrogen injection channels 13, positioned on either side of the first water inlet 6 and the first water outlet 8, respectively, directly facing the coarse-grained heat-affected zones on both sides of the weld. A liquid nitrogen injector is fixed inside each liquid nitrogen injection channel 13 to achieve liquid nitrogen spray cooling. The centerline of the liquid nitrogen injector should always be maintained 1 mm to 2 mm away from the outside of the weld fusion line to ensure that the liquid nitrogen 14 effectively acts on the coarse-grained heat-affected zone. More preferably, the distance between the tip of the liquid nitrogen injector and the thick plate 1 to be welded should be between 1 mm - 3 mm.

Furthermore, when the wall thickness of the thick plate 1 to be welded is less than 50mm, as shown in FIGS. 1 and 2, the back water-cooling assembly includes a back water-cooling backing plate 2 and a water-cooling pipe 3 installed inside the back water-cooling backing plate 2. The back water-cooling backing plate 2 is installed along the length direction of the thick plate 1 to be welded, positioned to the root of the welding groove and clamped tightly against the back side of the welding surface of the thick plate 1 to be welded. The water-cooling pipe 3 is arranged in a serpentine pattern inside the back water-cooling backing plate 2. The second water inlet 10 of the water-cooling pipe 3 is located at the bottom of the back water-cooling backing plate 2, and the second water outlet 11 is located at the top of the back water-cooling backing plate 2. During operation, the second water inlet 10 and the second water outlet 11 are connected to a secpmd constant-temperature circulating water tank to enable the provision of circulating cooling water. The temperature of both the first and second constant-temperature circulating water tanks is set between 20°C to 30°C.

Furthermore, the width W of the back water-cooling backing plate 2 should be at least three times of the maximum groove width W1 (i.e., W ≥ 3W1) to ensure adequate backside cooling effectiveness.

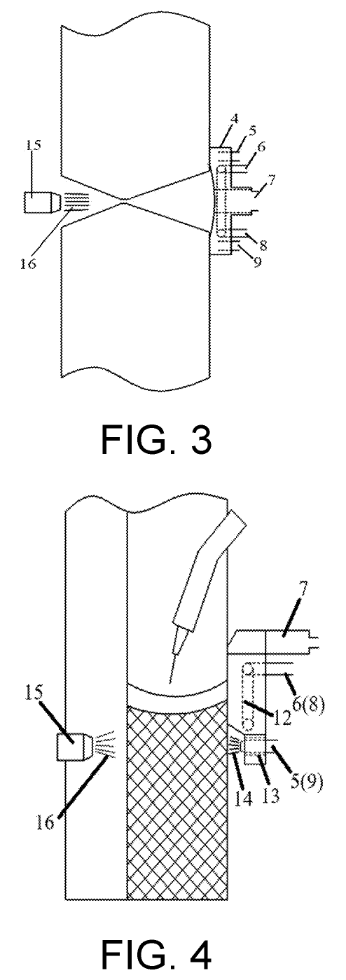

Furthermore, when the wall thickness of the thick plate 1 to be welded is greater than or equal to 50mm, as shown in FIGS. 3 and 4, during welding of the first side, the back water-cooling assembly includes a cooling water pipe 15. During welding, the cooling water pipe 15 moves synchronously with the front water-cooling assembly for spraying cooling water 16 onto the root of the welding groove, thereby cooling the back side of the welding surface via direct water-cooling. For welding the other side, the backside water-cooling assembly includes the back water-cooling backing plate 2 and a water-cooling pipe 3 fitted internal of the back water-cooling backing plate 2. The back water-cooling backing plate 2 is installed along the length direction of the thick plate 1 to be welded at the root of the groove to be welded and clamped tightly against the thick plate 1 to be welded . The water-cooling pipe 3 is arranged in a serpentine pattern inside the back water-cooling backing plate 2.

Existing electrogas upright welding techniques without an external cooling source only control heat input by restricting the cross-sectional area of the groove or rely on the function of water-cooling slider to accelerate the cooling of the weld, resulting in minimal effectiveness. In contrast, the disclosure not only adopts an external cooling source, but also cool the back side of the welding surface either through large-area water-cooling backings for overall temperature reduction or by direct water spraying onto the root of the welded joint during welding, whereas the coarse-grained heat-affected zone area of the welding surface where the liquid nitrogen is applied has a localized distortion of the temperature field. Under the combined effect of both methods, the cooling rate of the welding heat-affected zone is maximized, its high-temperature residence time is reduced, the width of the heat-affected zone is narrowed, and the resilience of the welded joint is enhanced.

The specific embodiments below further illustrate the technical solution provided by the present disclosure.

### Embodiment 1

This embodiment uses a high-strength steel plate with 40 mm thick as an example to provide a high-performance welding method for thick-wall electrogas upright welding based on liquid nitrogen rapid cooling assistance. The specific steps are described as follows.

S1: preparing the thick plates 1 to be welded and assemble as a pair, using a single-sided V-groove as the welding groove, with a groove angle of 35° and a root face of 3 mm is reserved. A gap of 2 mm is reserved during assembly; after assembly is completed, the configuration is shown in FIG. 1.

S2: installing the back water-cooling backing plate 2 with a width of 200 mm and it is installed at the root of the groove and clamped closely against the thick plate 1 to be welded; a serpentine water-cooling pipe 3 is arranged inside the back water-cooling backing plate 2; connecting the second water inlet 10 and the second water outlet 11 to a second constant-temperature circulating water tank via water pipes, respectively.

S3: installing the water-cooling slider 4, the center of the water-cooling slider 4 is the protective gas channel 7, while a first water inlet 6 and a first water outlet 8 of cooling water are located on either side of the protective gas channel 7; the water-cooling slider 4 is equipped with a cooling water pipe12 therein, and the first water inlet 6 and the first water outlet 8 are connected via water pipes to the first constant-temperature circulating water tank, respectively.

S4: performing root filling and installing the first liquid nitrogen injector 5 and the second liquid nitrogen injector 9 whereas the welding power source model used is YD-600KH; setting the temperature of both the first and second constant-temperature circulating water tanks to 20°C; starting the second constant-temperature circulating water tank to supply circulating water to the back water-cooling backing plate 2; starting the first constant-temperature circulating water tank to supply circulating water to the water-cooling slider 4; then, performing welding to fill the root area until the liquid nitrogen injection channels 13 disposed at the bottom of the water-cooling slider 4 is flush with the bottom of the thick plate 1 to be welded; after welding is stopped, installing the first liquid nitrogen injector 5 and the second liquid nitrogen injector 9 at a distance of 1 mm from the fusion lines on both sides of the weld, respectively, and adjusting their end faces to be 2 mm away from the test plate surface, which ensures that the liquid nitrogen effectively acts on the coarse-grained heat-affected zone.

S5: activating the first liquid nitrogen injector 5 and the second liquid nitrogen injector 9 and performing the electrogas upright welding; setting the welding parameters as follows: welding current is 450 A, welding voltage is 43 V, welding speed is 3.5 cm/min, welding torch oscillation amplitude is 12 mm, dwell time on each side is 0.4 seconds; the electrogas upright welding wire diameter is 1.6 mm, with a wire extension of 30 mm; and the protective gas used during welding is 100% CO₂, with a gas flow rate of 30 L/min.

Activating the first liquid nitrogen injector 5 and the second liquid nitrogen injector 9 and maintaining their liquid nitrogen output flow rate at 0.1 L/min, and then performing welding; during the welding, the back water-cooling backing plate 2 continuously overall cools the thick plate 1 to be welded; simultaneously, as the water-cooling slider 4 moves upward, the water-cooling slider 4 drives the first liquid nitrogen injectors 5 and the second liquid nitrogen injector 9 to move synchronously upward; the first liquid nitrogen injectors 5 and the second liquid nitrogen injector 9 continuously spray liquid nitrogen onto the coarse-grained heat-affected zone, providing localized rapid cooling until welding is completed.

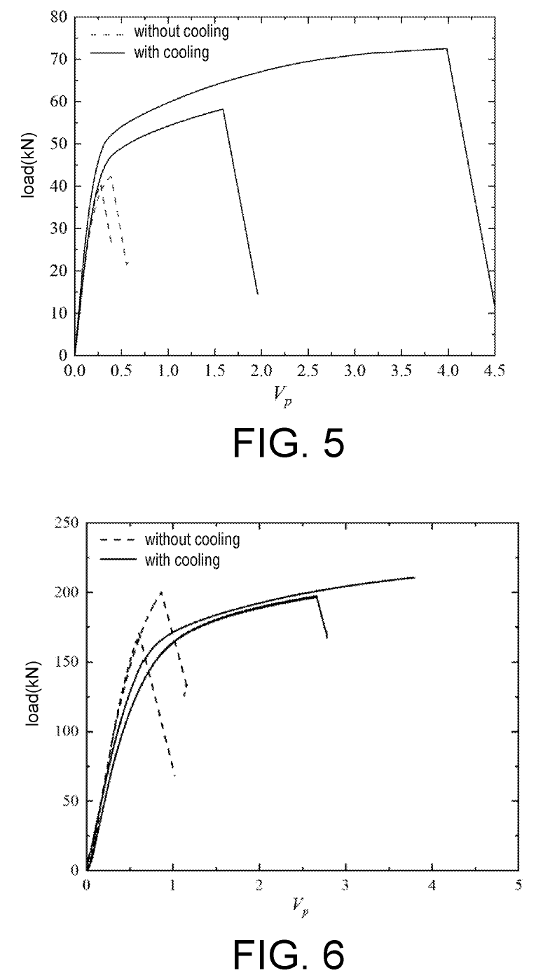

After welding is completed, a fracture toughness test is conducted on the welded joint according to GB 21143-2014; the sampling location is the heat-affected zone, and the test temperature was -20°C. The results were compared with those of a welded joint produced without cooling, and the test curves are shown in FIG. 5. The calculated CTOD values for the joint without cooling are 0.015 mm and 0.016 mm, and the CTOD values for Example 1 with cooling are 0.368 mm and 1.032 mm, indicating a substantial improvement in fracture toughness.

### Embodiment 2

This embodiment uses an high-strength steel plate with 80 mm thick as an example to provide a high-performance welding method for thick-walled electrogas upright welding based on liquid nitrogen rapid cooling assistance. The specific steps are as follows.

S1: preparing the thick plate 1 to be welded and assemble as a pair, using an X-groove as the welding groove; the groove angle on the welding face is 30°, with a groove depth of 45 mm and a root face of 3 mm is reserved and the groove angle on the back side of the welding face is 35°. A gap of 2 mm is reserved during assembly; after assembly is completed, the configuration is shown in FIG. 3.

S2: installing the cooling water pipe 15, and the cooling water pipe 15 acts directly on the root of the X-groove by spraying water; during welding, a moving speed upward of the cooling water pipe 15 is synchronized with that of the water-cooling slider 4 on the welding face.

S3 and S4 are the same as those in Embodiment 1.

S5: activating the first liquid nitrogen injector 5 and the second liquid nitrogen injector 9 and performing the electrogas upright welding; setting the welding parameters as follows: welding current is 460 A, welding voltage is 44 V, welding speed is 3.3 cm/min; other parameters are the same with those in embodiment 1.

S6: using the back water-cooling backing plate 2 to provide indirect cooling to a weld side that the welding has been completed; then, moving the water-cooling slider 4 to the unwelded side, activating the first liquid nitrogen injector 5 and the second liquid nitrogen injector 9to perform electrogas upright welding on the other side, repeating steps S3 and S4, setting the welding parameters as follows: welding current is 420 A, welding voltage is 41 V, welding speed is 3.4 cm/min; other parameters are the same with those in embodiment 1.

After welding, a fracture toughness test is conducted on the welded joint according to GB 21143-2014; the sampling location is the heat-affected zone, and the test temperature is -20°C. The results are compared with those of a welded joint produced without cooling, and the test curves are shown in FIG. 6. The calculated CTOD values for the joint without cooling are 0.021 mm and 0.072 mm, and the CTOD values for embodiment 2 with cooling are 0.421 mm and 0.694 mm, indicating a substantial improvement in fracture toughness.

The above results indicates that with the combination of the welding process parameters developed and the cooling method in this disclosure, the fracture toughness of the heat-affected zone in electrogas upright welded joints is significantly enhanced.

In the disclosure, the terms "first" and "second" are only used for descriptive purposes and cannot be understood as indicating or implying relative importance or implicitly indicating the number of indicated technical features. Thus, the features defined with "first" and "second" may explicitly or implicitly include one or more of these features. In the description of the disclosure, "plurality" means two or more than two, unless otherwise expressly and specifically defined.

Additionally, references throughout this specification to "one embodiment," "an example," or similar language indicate that specific features, structures, or characteristics described in connection with that embodiment are included in at least one embodiment of the present application. Therefore, the phrases "in one embodiment," "in an embodiment," and similar language appearing throughout this specification may, but do not necessarily, all refer to the same embodiment.

The above descriptions are only preferred embodiments of the present disclosure and are not intended to limit the present disclosure. Any modifications, equivalent substitutions and improvements made within the spirit and principles of the present disclosure shall be included in the protection scope of the present disclosure.

What is claimed is:

1. A high-performance welding device for thick-wall electrogas upright welding based on liquid nitrogen rapid cooling, wherein the welding device characterized in that the high-performance welding device comprising a welding torch (17), a back water-cooling assembly, and a front water-cooling assembly; the welding torch (17) is used for welding a welding groove through electrogas upright welding; the back water-cooling assembly is arranged on a back side of the welding surface of the thick plate (1) to be welded for performing water-cooling on a back side of the welding surface; the front water-cooling assembly is arranged on the welding surface of the thick plate (1) to be welded and moves with the welding torch (17); the front water-cooling assembly comprises a water-cooling slider (4) and a protective gas channel (7), a cooling water channel (12), and a liquid nitrogen injection channel (13) arranged inside the water-cooling slider (4); the protective gas channel (7) is used for providing protective gas during welding process; the cooling water channel (12) is used for introducing cooling water during the welding process to cool the water-cooling slider (4); the liquid nitrogen injection channel (13) is used for spraying liquid nitrogen onto a welded joint during the welding process to achieve local rapid cooling of a heat-affected zone of the welded join,
wherein the protective gas channel (7) is arranged at a center of the water-cooling slider (4); a first water inlet (6) and a first water outlet (8) of the cooling water channel (12) are arranged on two sides of the protective gas channel (7), respectively; two liquid nitrogen injection channels (13) are arranged on two sides of the first water inlet (6) and the first water outlet (8), respectively,
wherein each of the two liquid nitrogen injection channels (13) is provided with a first liquid nitrogen injector (5) and a second liquid nitrogen injector (9) therein; center lines of the first liquid nitrogen injector (5) and the second liquid nitrogen injector (9) are respectively distanced 1 mm to 2 mm away from outside of a weld fusion line; distances between ends of the first liquid nitrogen injector (5) and the second liquid nitrogen injector (9) to the welding surface of the thick plate (1) to be welded is 1 mm to 3 mm,
wherein when a wall thickness of the thick plate (1) to be welded is greater than 30 mm and less than 50 mm, the welding groove is a single-sided V-groove, the back water-cooling assembly comprises a back water-cooling backing plate (2) and a water-cooling pipe (3) arranged inside the back water-cooling backing plate (2); the back water-cooling backing plate (2) is arranged along a length direction of the thick plate (1) to be welded at a root of the welding groove to be welded and clamped tightly to the thick plate (1) to be welded; the water-cooling pipe (3) is distributed in a serpentine pattern inside the back water-cooling backing plate (2) , and the back water-cooling assembly is applied to cool the back side of the welding surface in a way of indirect water-cooling;
wherein that when the wall thickness of the thick plate (1) to be welded is greater than or equal to 50 mm, the welding groove is an X-groove, during welding of a first side, the back water-cooling assembly comprises a cooling water pipe (15), and the cooling water pipe (15) moves synchronously with the front water-cooling assembly during welding for spraying water towards a root of the welding groove, and the back water-cooling assembly is applied to cool the back side of the welding surface in a way of direct water-cooling; during welding of the other side, the back water-cooling assembly comprises a back water-cooling backing plate (2) and a water-cooling pipe (3) arranged inside the back water-cooling backing plate (2); the back water-cooling backing plate (2) is arranged at the root of the welding groove to be welded along a length direction of the thick plate (1) to be welded and clamped tightly to the thick plate (1) to be welded; the water-cooling pipe (3) is distributed in a serpentine pattern inside the back water-cooling backing plate (2), and the back water-cooling assembly is applied to cool the back side of the welding surface in the way of indirect water-cooling.

2. The high-performance welding device according to claim 1, characterized in that, wherein a water inlet of the water-cooling pipe (3) is arranged at a bottom of the back water-cooling backing plate (2), and a water outlet of the water-cooling pipe (3) is arranged at a top of the back water-cooling backing plate (2).

3. The high-performance welding device according to claim 1, characterized in that, wherein a width of the back water-cooling backing plate (2) is more than 3 times of a maximum groove width of the welding groove.
